(19) United States
(12) Patent Application Publication
(10) Pub. No.: US 2008/0092810 A1
(43) Pub. Date: Apr. 24, 2008

(54) Paint shield having flexible member

(76) Inventor: Young Dong Kim, Sunnyvale, CA (US)

Correspondence Address: BUCHANAN, INGERSOLL & ROONEY PC, POST OFFICE BOX 1404, ALEXANDRIA, VA, 22313-1404, US

(21) Appl. No.: 11/585,710

(22) Filed: Oct. 23, 2006

(51) Int. Cl. B05C 5/00; B05C 11/11; B05B 15/04

(52) U.S. Cl. 118/504; 118/300; 118/301; 118/200

(57) ABSTRACT

Device for protectively covering a first portion of a first surface when a second portion of a second surface adjoining the first surface is painted. The device includes a plate having a generally elongated rectangular shape and a distal edge. One side of the plate defines a working surface against which paint is collected during painting the second portion. The device also includes a flexible member that has a tip coupled to the plate, an elongated middle portion formed of flexible material and operative to generate a resilient force upon bending, and a bottom portion to be coupled to an end of an elongated handle. When a user bends the middle portion and positions the distal end against one of the first and second surfaces and positions the other end of the handle coupled to the bottom portion against a third surface, the device is held in place by itself due to the resilient force.

### BACKGROUND OF THE INVENTION

The present invention generally relates to paint accessories, and more particularly to a paint shield positioned against a flat surface or corner to keep paint from being smeared thereon.

Currently, wall and ceiling painting is now accomplished by spray painting and/or roller painting. Typically, a ceiling is painted with a paint or texturing which is different from that of the walls. Additionally, some walls are also painted a different color from a wall adjacent thereto. As such, a ceiling and walls are not painted contemporaneously. Therefore, protecting the first-painted wall or ceiling as the second-painted ceiling or wall surface is painted, respectively, is desired.

U.S. Pat. No. 5,103,762 to Long et al. discloses a spray paint shield for manually protectively covering a portion of a wall or ceiling when the adjoining ceiling or wall portion, respectively, is being spray painted. FIG. 1A shows a schematic top view of the spray paint shield disclose in the Long et al. '762 patent. As depicted, the shield 10 includes an elongated flexible sheet 12, a U-shaped member 14 secured to the sheet 12 by rivets 16, a hand grip 18, and a fastening mechanism for pivotally coupling the hand grip 18 to the flexible sheet 12. FIG. 1B shows a schematic side view of the spray paint shield 10 in use. During spray painting, a user holds the hand grip 18 in one hand to position the distal end of the sheet 12 along the corner C while the spray gun is held in other hand. Manipuation of both the spray gun and shield can detract from the effective use thereof and cause fatigue upon extended use thereof. Especially, when the user must devote one hand to maintaining or steadying his foothold, as by holding onto a ladder, and has only one hand available for applying paint, the shield 10 can be significantly cumbersome.

FIG. 2 shows a typical use of a conventional paint roller assembly 20 in painting a wall in a different color than the ceiling. In general, the paint roller assembly 20 has a roller 24 and a hand grip 22. To prevent paint splatter and/or inadvertent smear of paint on the ceiling surface, a user can apply the paint up to a certain distance D1, say about 3 inches, from the corner C. Then, the unpainted portion of the wall is painted by use of a brush later. Brush painting is time consuming and cumbersome since the painter may need to carry a ladder and move up and down the ladder. As such, the painter can save time and effort if the distance D1 is reduce. In some cases, a paint tape or masking tape 21 may be applied on the ceiling to prevent paint splatter and/or inadvertent smear. The paint tape may allow the painter to reduce the distance D1. However, applying the tape around the corner also requires considerable amount of time and effort. As such, there is a need for a device that functions as a paint spray shield providing enhanced flexibility in use thereof and reduces the area to be brush painted.

### SUMMARY OF THE INVENTION

In one embodiment, a device for protectively covering a first portion of a first surface when a second portion of a second surface adjoining the first surface is painted includes: a plate having a generally elongated rectangular shape and a distal edge, one side of the plate defining a working surface against which paint is collected during painting the second portion; and a flexible member having a tip coupled to the plate, an elongated middle portion formed of flexible material and operative to generate a resilient force upon bending, and a bottom portion to be coupled to an end of an elongated handle. When a user bends the middle portion and positions the distal end against one of the first and second surfaces and positions the other end of the handle coupled to the bottom portion against a third surface, the device is held in place by itself due to the resilient force.

In another embodiment, a device for protectively covering a first portion of a first surface when a second portion of a second surface adjoining the first surface is painted includes: a plate having a generally elongated rectangular shape and a distal edge, one side of the plate defining a working surface against which paint is collected during painting the second portion; and a flexible member having a tip coupled to the plate, an elongated middle portion formed of flexible material and operative to generate a resilient force upon bending. When a user bends the middle portion and positions the distal end against one of the first and second surfaces and positions an end of the middle portion opposite to the tip against a third surface, the device is held in place by itself due to the resilient force.

These and other features, aspects and advantages of the present invention will become better understood with reference to the following drawings, description and claims.

### BRIEF DESCRIPTION OF THE DRAWINGS

FIG. 1A shows a schematic top view of an existing spray paint shield;

FIG. 1B shows a schematic side view of the spray paint shield shown in FIG. 1A in use;

FIG. 2 shows a typical use of a conventional paint roller assembly in painting a wall;

FIG. 3 shows a schematic top view of a paint shield apparatus in accordance with the present invention;

FIG. 4 shows a schematic bottom view of the paint shield assembly shown in FIG. 3;

FIG. 5 shows a schematic perspective view of the fixture shown in FIG. 4;

FIG. 6 shows a schematic transverse cross sectional view of the paint shield assembly shown in FIG. 4, taken along the line 6-6;

FIGS. 7A, 7B show schematic perspective and side views of a spring clip shown in FIG. 6, respectively.

FIG. 8 shows a schematic perspective view of another embodiment of a fixture in accordance with the present invention;

FIG. 9 shows a schematic front view of the fixture shown in FIG. 8;

FIG. 10 shows a schematic transverse cross sectional view of another embodiment of a paint shield assembly, taken along the line 10-10 (FIG. 9), in accordance with the present invention;

FIGS. 11A-11c show schematic diagrams of several embodiments of a flexible member in accordance with the present invention;

FIGS. 12A, 12B show schematic perspective and top views of the adapter shown in FIG. 3;

FIG. 12C shows how to use the adapter shown in FIGS. 12A-12B with a conventional handle;

FIGS. 13A-14B illustrate how to use the paint shield apparatus shown in FIG. 3;

FIG. 15A shows a partial front view of a wall surrounding a window and the paint shield apparatus shown in FIG. 3 used in painting the wall; and

FIG. 15B shows a schematic cross sectional view of the wall and window shown in FIG. 15A, taken along the line 15-15;

FIG. 16A is a schematic top view of still another embodiment of a paint shield assembly in accordance with the present invention;

FIG. 16B is a schematic top view of yet another embodiment of a paint shield assembly in accordance with the present invention; and

FIG. 16C is a schematic top view of a further embodiment of a paint shield assembly in accordance with the present invention.

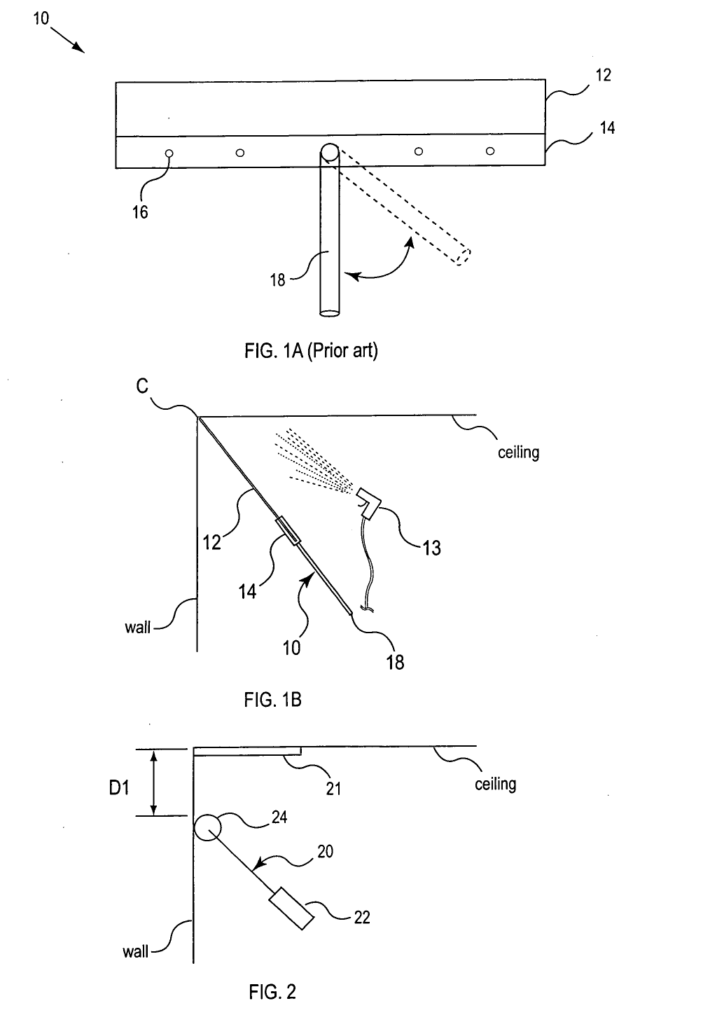

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

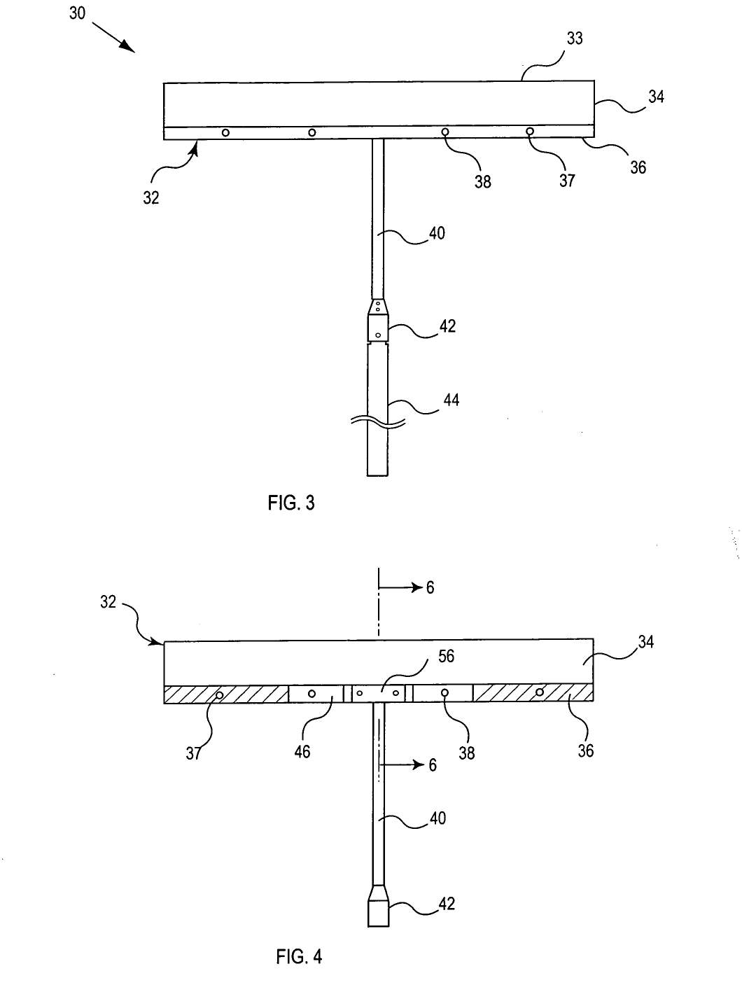

FIG. 3 is a schematic top view of a paint shield apparatus shown at 30 and having a paint shield assembly 32 and an elongated handle 44 in accordance with the present invention. FIG. 4 is a schematic bottom view of the paint shield assembly 32 shown in FIG. 3. The shield assembly 32 includes: a plate 34 having a distal edge 33; a plate holder or reinforcement 36 secured to the plate by fasteners 37, such as rivets; a fixture 46 secured to the plate holder 36 by fasteners 38; a flexible member 40; a spring clip 56 for detachably securing the flexible member to the fixture; and an adapter 42 for connecting the flexible member 40 the handle 44.

The plate 34 is formed of, but not limited to, plastic or metal and secured to the plate holder 36. The material for the plate 34 is selected such that the plate is not deformed due to bending force applied thereto in use. The plate 34 generally has an elongated rectangular shape with a width of, preferably but is not limited to, 4-6 feet. The plate holder 36 is formed of, but not limited to, plastic or aluminum and operative to support the plate. As a variation, the plate 34 may be bonded to the plate holder 36 by suitable bonding material, such as epoxy. The distal edge 33 can be place into a corner between the ceiling and wall or between window frame and wall, for instance, so that a portion of one surface can be protected while the adjoining surface is painted. Further detailed description of how to use the apparatus 30 is given in conjunction with FIGS. 13A-15B.

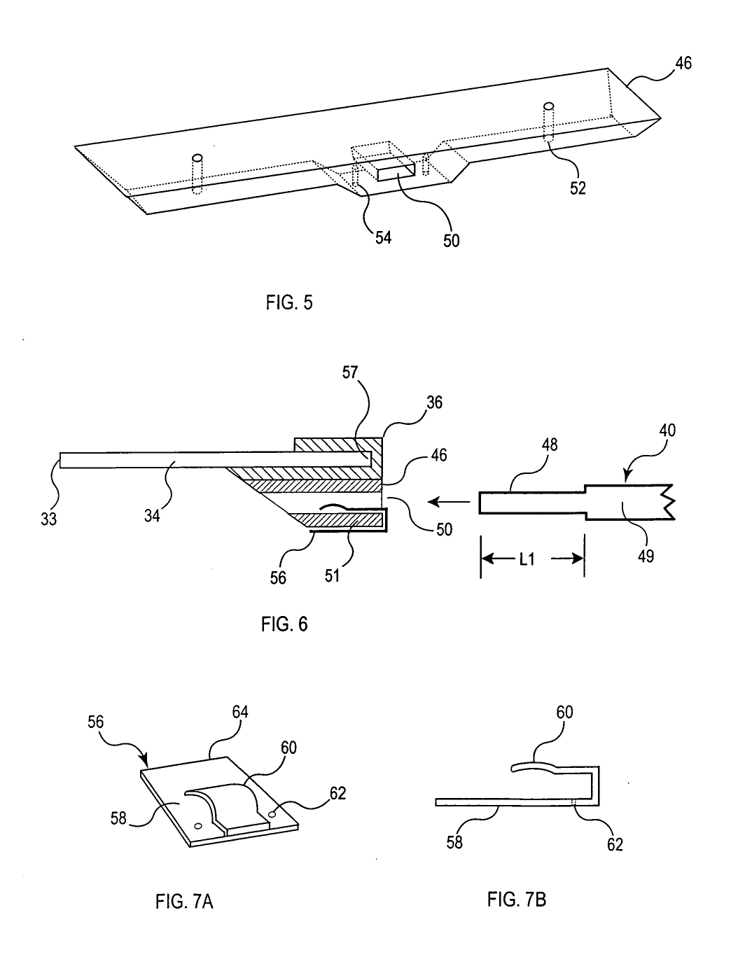

FIG. 5 shows a schematic perspective view of the fixture 46 shown in FIG. 4. As depicted, the fixture includes: an opening or slot 50 for receiving the flexible member 40, more specifically the tip portion of the flexible member; one or more through holes 52 through which the fasteners 38 pass; and one ore more threaded holes 54. The fixture 46 is made of, but not limited to, aluminum. Preferably, the fixture 46 may be manufactured by a conventional die casting technique.

FIG. 6 shows a schematic cross sectional view of the paint shield assembly 32, taken along the line 6-6 (FIG. 3). As depicted, the plate holder 36 has a groove or channel for receiving the proximal edge portion 57 of the plate 34. A tip 48 of the flexible member 40 detachably engages in the slot 50 formed in the fixture 46. A spring clip 56 is used to hold the tip 48 in place when the tip is engaged in the slot 50. The spring clip 56 forms a quickly detachable connection mechanism such that the flexible member 40 can be released from the slot 50 by simply pulling them apart. The tip 48 has a generally flat rectangular shape, while the middle portion 49 can have any suitable cross sectional geometry.

FIGS. 7A, 7B show schematic perspective and side views of the spring clip 56, respectively. As depicted, the spring clip 56 includes a bottom panel 58 having one or more holes 62 and a curved spring portion 60. The spring clip 56 is secured to the fixture 46 by one or more fasteners that pass through the holes 62 and engage with the threaded holes 54 formed in the fixture 46. The spring portion 60, when pressed down by the tip 48, generates a resilient force such that the tip 48 is pushed against the inner surface of the slot 50 thereby preventing accidental disengagement of the tip 48 from the slot 50.

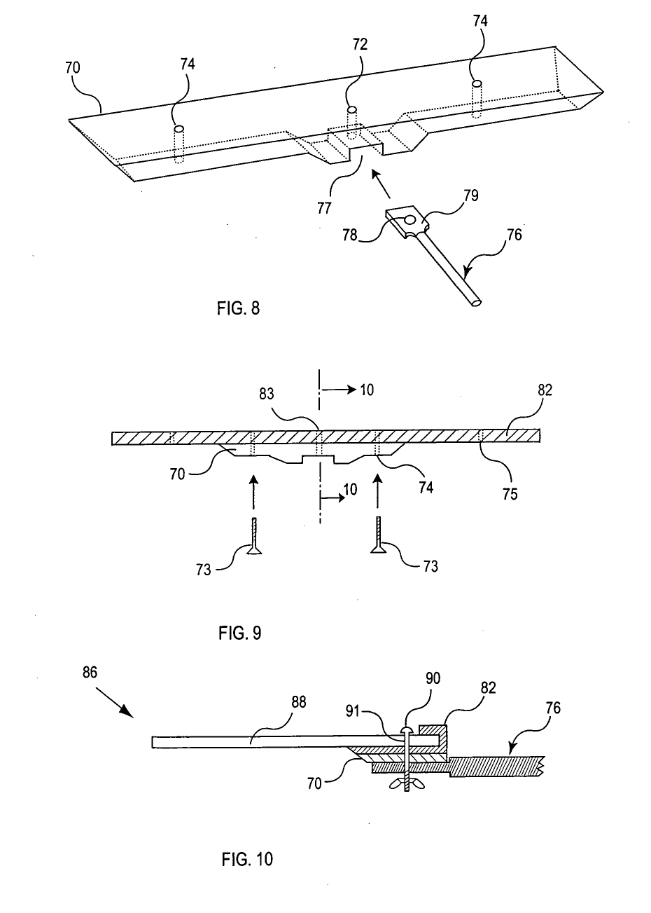

FIG. 8 shows a schematic perspective view of another embodiment 70 of a fixture in accordance with the present invention. The fixture 70 is similar to the fixture 46 with exceptions that the bottom side of the opening or slot 77 is open and that a through hole 72 is formed therein. The fixture 70 is formed of, but not limited to, aluminum. Preferably, the fixture 46 may be manufactured by a conventional die casting technique. A tip 79 of a flexible member 76 has a through hole 78 that is aligned with the hole 72 when the tip 79 engages with the fixture 70.

FIG. 9 shows a schematic front view of the fixture 70 secured to a plate holder 82 by fasteners 73 that pass through the holes 74. The plate holder 82 is similar to the holder 36 with an exception that the plate holder 82 has a through hole 83 aligned with the hole 72. Holes 75 are used to secure the plate holder 82 to a plate. FIG. 10 shows a schematic transverse cross sectional side view of another embodiment of a paint shield assembly 86, taken along the line 10-10 (FIG. 9), in accordance with the present invention. The assembly 86 includes the plate holder 82, the fixture 70, a plate 88 secured to the plate holder and fixture, and the flexible member 76. It is noted that the plate 88 is similar to the plate 34 with an exception that the plate 88 has a through hole or aperture 91. As depicted, a threaded fastener 90 pass through the holes 83, 72, 78, and 91 such that the plate 88, plate holder 82, fixture 70, and flexible member 76 are secured to each other and moved as one piece.

It is noted that the number of the holes 52, 54, 62, 72, 74, 75, 78, 83, and 91 can be varied without deviating from the sprit and scope of the present teachings. For instance, the fixture 70 can have more than two holes 74 for securing the fixture 70 to the plate holder 82.

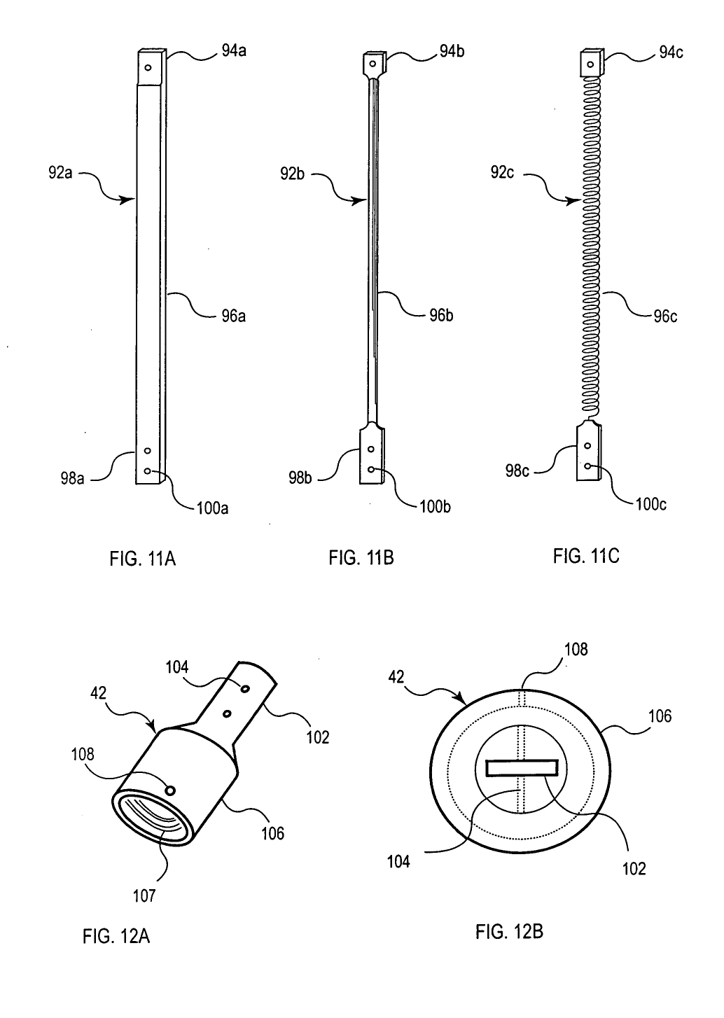

FIGS. 11A-11C show schematic diagrams of several embodiments 92a-92c of a flexible member in accordance with the present invention, wherein the embodiments 92 might be of the types used in the paint shield assemblies 32, 86. As depicted, each flexible member has a tip 94, an elongated middle portion 96, and a bottom portion 98. The tip 94 is configured to fit into slots 50, 77 formed in the fixtures. It should be apparent to those of ordinary skill that slots can have other shapes, such as circular cylinder, and the tip can be shaped to form a counterpart to the slot. The middle portion 96 is formed of flexible material and have various cross sectional shapes. For example, middle portions 96a and 96b respectively have rectangular and circular cross sections. The middle portion 96c is formed of a spring. The cross sectional dimension and material for the middle portion 96 are selected to allow the user to bend the middle portion thereby to make the apparatus have an intended posture while to provide a sufficient resilient force to make the apparatus maintain the posture by itself when in use as described with reference to FIGS. 13A-15B. The bottom portion 98 has one or more holes 100 for receiving suitable fasteners. The flexible member may be formed of various materials, such as aluminum, composite material, fiber glass, and steel.

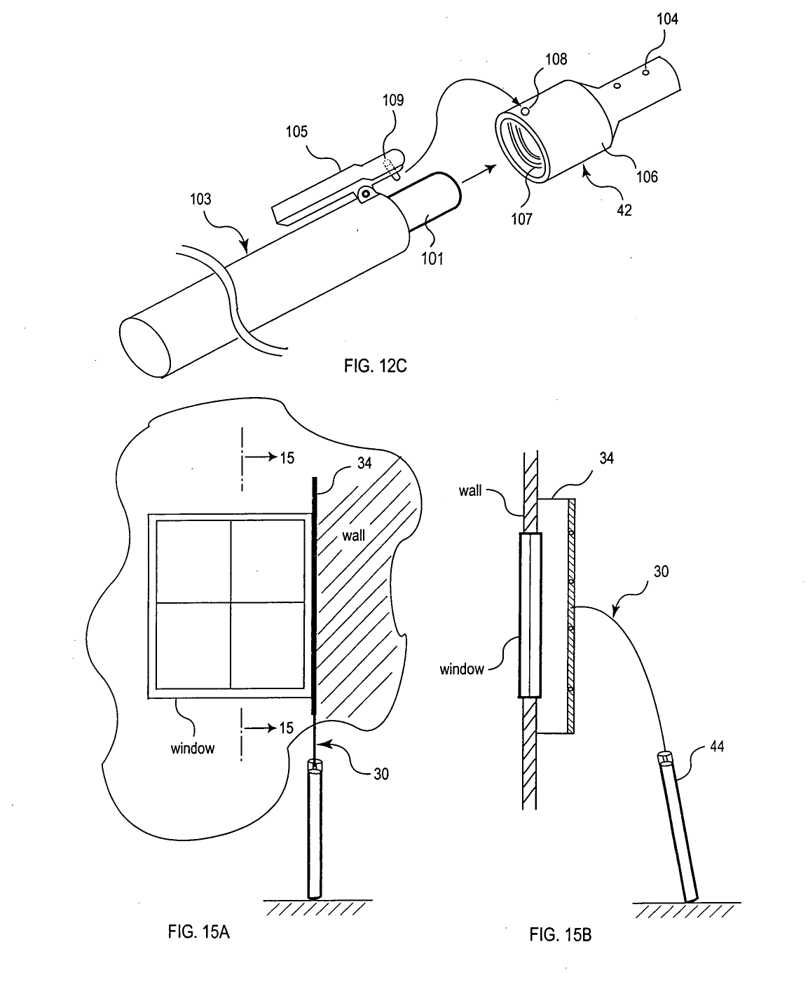

FIGS. 12A, 12B show schematic perspective and top views of the adapter 42 (FIG. 3) in accordance with the present invention. As depicted, the adapter 42 includes an upper portion 102 for engaging with the bottom portion 98 of the flexible member 92 and a lower portion 106 for engaging with the handle 44 (FIG. 3). To paint a top portion of a high wall, the bottom side of the hand grip 22 (FIG. 2) has standard-size threads formed on the inner surface thereof, wherein the female threads engage with male threads formed on the tip portion of a conventional elongated handle or bar. The lower portion 106 has the same standard-size threads 107 formed on the inner surface thereof such that the conventional elongated handle can be coupled to the lower portion 106 and used as the handle 44. FIG. 12C shows how to use the adapter 42 with another conventional type of handle 103. The handle 103 may include a generally cylindrical tip portion 101 and a clip 105 having a protrusion 109. The tip portion 101 may have a diameter smaller than that of the female thread 107 such that the tip portion 101 can snugly fit into the lower portion. Then, the protrusion 109 engages with the hole 108 to securely connect the handle 103 to the adapter 42. The upper portion 102 has one or more holes 104 that are aligned with the holes 100 formed in the bottom portion 98 of the flexible member 92. Suitable fasteners, such as screws or bolts, pass through the holes 100, 104 thereby secure the adapter 42 to the bottom portion 98. The adapter 42 may be formed of any suitable material, such as plastic.

FIGS. 13A-15B show how to use the paint shield apparatus 30 shown in FIG. 3. As depicted in FIG. 13A, when a user spray paints the ceiling, the flexible member 40 of the paint shield 30 is arched to be convex downward. The distal edge 33 of the plate 34 is tightly placed into the corner C so that the top portion of the wall is protected while spray painting the ceiling. The bottom of the handle 44 is positioned on the floor. As the resilient force of the flexible member 40 holds the paint shield apparatus 30 in place, the user can leave the paint shield unattended during spray painting, which allows the user to use both hands for other work than holding the handle 44. This provides a great advantage compared to the conventional paint spray shield that requires one hand for holding the shield during spray painting. Furthermore, the plate 34 is positioned close to the wall to provide more space between the plate and the ceiling for the user compared to the conventional paint spray shield (FIG. 2).

The apparatus 30 can also be used in conjunction with a conventional paint roller assembly, as depicted in FIG. 13B. To prevent paint splatter and/or inadvertent smear of paint on the ceiling surface, the flexible portion 40 of the paint shield 30 is arched to be convex upward. The plate 34 is positioned close to the ceiling surface such that the roller can reach closer to the corner C. The width D2 of the unpainted portion can be reduced, e.g., down to ½ inch, which is significantly smaller than that generated by the existing approach. As discussed above, painting the unpainted portion with a brush is time consuming and cumbersome. Thus, the painter can save time and effort to paint walls by use of the apparatus 30.

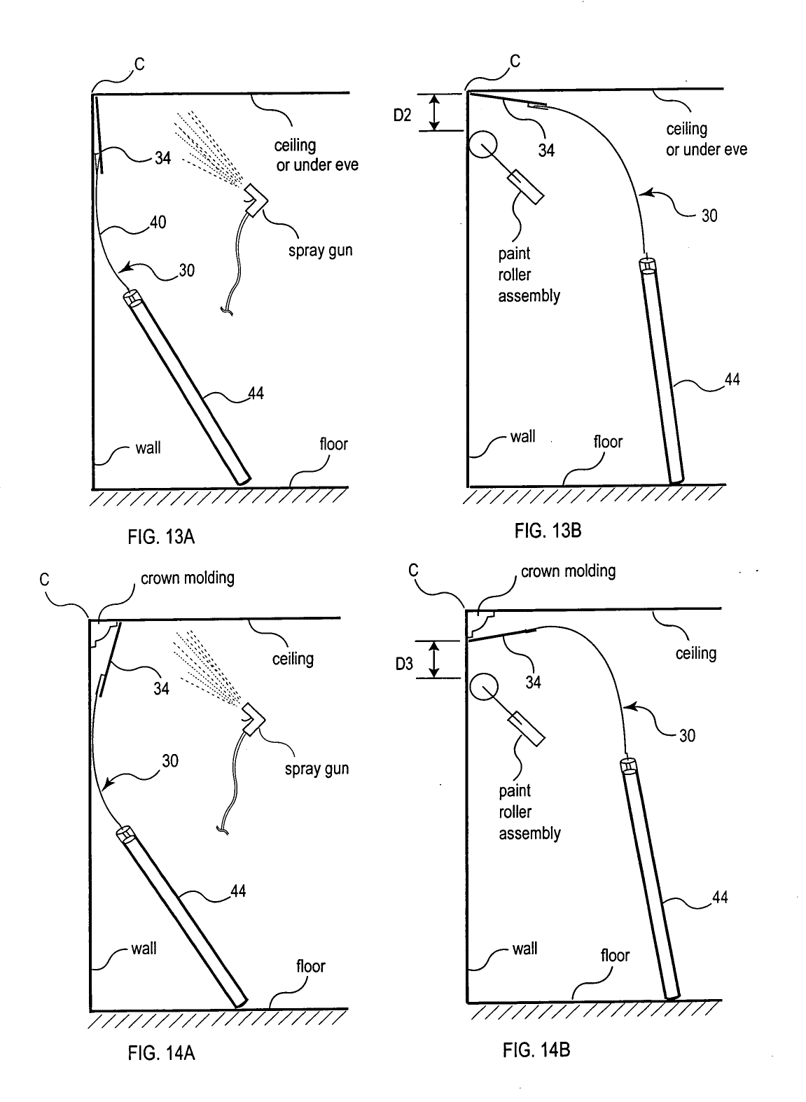

FIGS. 14A-14B show how to use the paint shield apparatus 30 in painting a ceiling and a wall, wherein a crown molding is positioned in the corner C. As depicted in FIG. 14A, the apparatus 30 is used to protect the crown molding and wall while spray painting the ceiling surface. Then, as illustrated in FIG. 14B, the crown molding and the ceiling are protected by the apparatus 30 during painting the wall with a roller. For the same reasons set forth above, the distance D3 is reduced to allow the painter to complete the painting of the wall with less effort.

Apparently, the apparatus 30 can be used to paint other types of two adjoining surfaces, such as a wall and under eaves, in the similar manner as illustrated in FIGS. 13A-14B. The paint shield 30 can also be used to protect a window during painting a wall surrounding the window. FIGS. 15A shows a partial front view of a wall surrounding a window and the apparatus 30 used in painting the wall. FIG. 15B shows a schematic cross sectional side view of the wall and window shown in FIG. 15A, taken along the line 15-15. As depicted in FIG. 15A, the plate 34 of the paint shield 30 is position normal to the wall so that the window is protected while spray/roller painting the shaded area of the wall.

It is noted that FIGS. 13A-15B illustrate how to use the paint shield apparatus 30. However, it should be apparent to those of ordinary skill that the paint shield apparatus 86 can be also used in the same manner as described in FIGS. 13A-15B. Also, the embodiment 92a-92c of a flexible member and the embodiments of the handle 44, 103 can be used for both the assemblies 32 and 86.

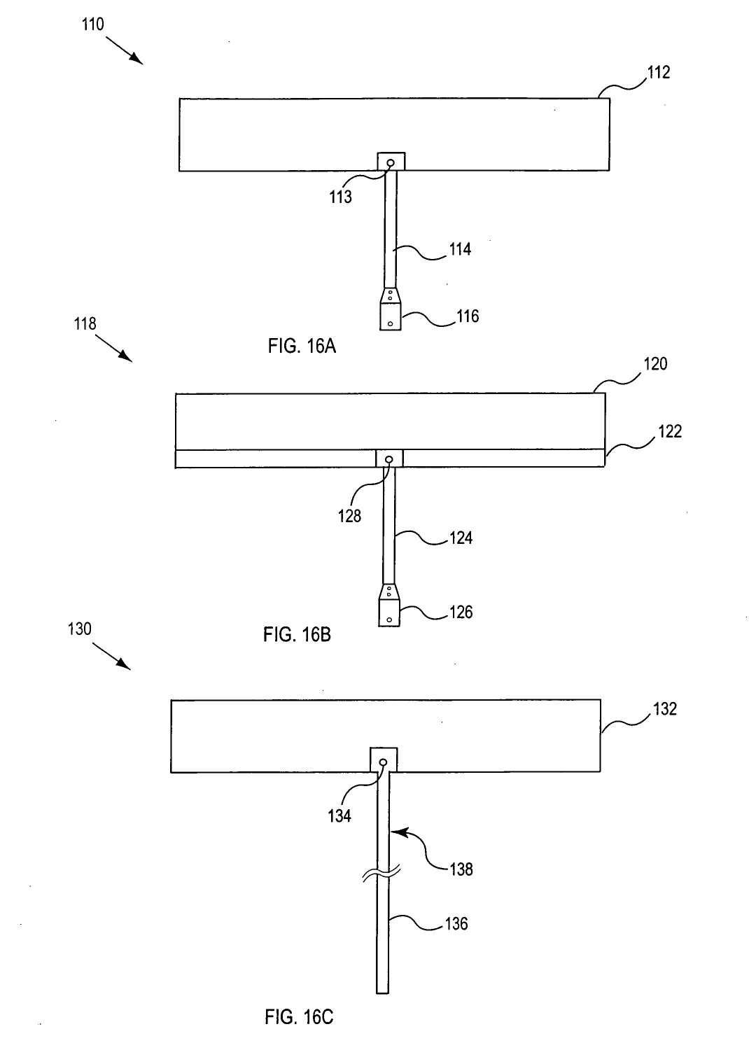

FIG. 16A is a schematic top view of still another embodiment of a paint shield assembly 110 in accordance with the present invention. The paint shield assembly 110 includes a plate 112, a flexible member 114, and an adapter 116. The assembly 110 is similar to the assembly 32 shown in FIG. 4 with an exception that the flexible member 114 is directly connected to the plate 112 by a suitable fastener(s) 113, i.e., the plate holder 36 and fixture 46 are not used in the assembly 110. FIG. 16B is a schematic top view of yet another embodiment of a paint shield assembly 118 in accordance with the present invention. The assembly 118 includes a plate 120, a plate holder 122 secured to the plate, a flexible member 124, and an adapter 126. The assembly 118 is similar to the assembly 32 shown in FIG. 4 with an exception that the flexible member 124 is directly connected to the plate holder 122 by a suitable fastener(s) 128, i.e., the fixture 46 is not used in the assembly 118.

In FIGS. 16A-16B, the embodiments of a paint shield assembly include an adapter for coupling with a handle 44. Alternatively, the middle portion 96 (FIG. 12) of the flexible members 92 can be extended replacing the bottom portion of the flexible member, adapter, and the handle. For instance, as depicted in FIG. 16C, an alternative embodiment of the assembly 130 may include a plate 132 secured to the tip portion of the flexible member 138 by a suitable fastener(s) 134, wherein the middle portion 136 of the flexible member 138 is extended to reach the floor when in use.

It should be understood, of course, that the foregoing relates to exemplary embodiments of the invention and that modifications may be made without departing from the spirit and scope of the invention as set forth in the following claims.

What is claimed is:

1. A device for protectively covering a first portion of a first surface when a second portion of a second surface adjoining the first surface is painted, comprising:
a plate having a generally elongated rectangular shape and a distal edge, one side of said plate defining a working surface against which paint is collected during painting the second portion; and
a flexible member having a tip coupled to said plate, an elongated middle portion formed of flexible material and operative to generate a resilient force upon bending, and a bottom portion to be coupled to an end of an elongated handle;
wherein said device is held in place by itself due to the resilient force when a user bends said middle portion and positions said distal end against one of the first and second surfaces and positions the other end of the handle coupled to the bottom portion against a third surface.

2. A device as recited in claim 1, wherein the middle portion is selected from a group consisting of a rectangular cylinder, a circular cylinder, and an elongated spring.

3. A device as recited in claim 1, further comprising:
an adapter including an upper portion for engaging with said bottom portion and a lower portion having threaded inner surface for engaging with said handle.

4. A device as recited in claim 3, wherein said upper portion of said adapter includes at least one first through hole and said bottom portion of said flexible member includes at least one second through hole and wherein, when said bottom portion engages with said upper portion, said first and second holes are aligned with each other such that at least one fastener can pass therethrough and secure said upper portion to said bottom portion.

5. A device as recited in claim 3, wherein the handle includes a generally cylindrical tip portion and a clip that is positioned in proximity to said tip portion and that has a protrusion and wherein said lower portion includes a hole that is formed on the wall thereof and operative to engage with the protrusion when the tip portion is inserted into said inner surface of said lower portion.

6. A device as recited in claim 1, further comprising:
a plate holder securely attached to a proximal end portion of said plate and operative to hold said plate;
wherein said tip is secured to said plate holder.

7. A device as recited in claim 6, wherein said plate holder is secured to said plate by bonding material or at least one fastener.

8. A device as recited in claim 1, further comprising:
a plate holder securely attached to a proximal end portion of said plate and operative to hold said plate; and
a fixture securely attached to said plate holder and including an opening for receiving said tip and a fastening mechanism for securing said tip to said fixture.

9. A device as recited in claim 8, wherein said plate holder is secured to said plate by bonding material or at least one fastener.

10. A device as recited in claim 8, wherein each of said plate, plate holder, fixture, and tip respectively includes a hole and wherein the holes are aligned with each other such that at least one fastener for securing said plate, plate holder, fixture, and tip to each other, can pass therethrough.

11. A device as recited in claim 8, wherein said fastening mechanism includes a spring clip having a curved spring portion designed to be positioned between a surface defining said opening and said tip and designed to generate a resilient force to push said tip against the surface defining said opening thereby prevent accidental disengagement of said tip from said fixture.

12. A device as recited in claim 11, wherein said spring clip is secured to said fixture by one or more fasteners.

13. A device for protectively covering a first portion of a first surface when a second portion of a second surface adjoining the first surface is painted, comprising:
a plate having a generally elongated rectangular shape and a distal edge, one side of said plate defining a working surface against which paint is collected during painting the second portion; and
a flexible member having a tip coupled to said plate, an elongated middle portion formed of flexible material and operative to generate a resilient force upon bending;
wherein said device is held in place by itself due to the resilient force when a user bends said middle portion and positions said distal end against one of the first and second surfaces and positions an end of said middle portion opposite to said tip against a third surface.

14. A device as recited in claim 13, wherein the middle portion is selected from a group consisting of a rectangular cylinder, a circular cylinder, and an elongated spring.

15. A device as recited in claim 13, further comprising:
a plate holder securely attached to a proximal end portion of said plate and operative to hold said plate;
wherein said tip is secured to said plate holder.

16. A device as recited in claim 13, wherein said plate holder is secured to said plate by bonding material or at least one fastener.

17. A device as recited in claim 13, further comprising:
a plate holder securely attached to a proximal end of said plate and operative to hold said plate; and
a fixture securely attached to said plate holder and including an opening for receiving said tip and a fastening mechanism for securing said tip to said fixture.

18. A device as recited in claim 17, wherein said plate holder is secured to said plate by bonding material or at least one fastener.

19. A device as recited in claim 17, wherein said fastening mechanism includes a spring clip having a curved spring portion designed to be positioned between a surface defining said opening and said tip and designed to generate a resilient force to push said tip against the surface defining said opening thereby prevent accidental disengagement of said tip from said fixture.

20. A device as recited in claim 17, wherein said spring clip is secured to said fixture by one or more fasteners.
